(19) United States
(12) Patent Application Publication
(10) Pub. No.: US 2015/0230078 A1
(43) Pub. Date: Aug. 13, 2015

(54) Secure Ad Hoc Data Backup to Nearby Friend Devices

(71) Applicant: Apple Inc., Cupertino, CA (US)

(72) Inventors: Anil K. Kandangath, Santa Clara, CA (US); Xiaoyuan Tu, Sunnyvale, CA (US)

(73) Assignee: Apple Inc., Cupertino, CA (US)

(21) Appl. No.: 14/176,455

(22) Filed: Feb. 10, 2014

(51) Int. Cl. H04W 8/20; G06F 11/14; H04W 84/18

(52) U.S. Cl. CPC H04W 8/205; H04W 84/18; G06F 11/1412; G06F 2201/80

(57) ABSTRACT

Ad hoc data backup for mobile devices is disclosed. When the user of a mobile device has poor or no data connectivity with a network-based storage system and friends are identified that are in the vicinity of the user, backup data is transferred from the user's mobile device to one or more of the friend devices using peer-to-peer connections.

### TECHNICAL FIELD

This disclosure relates generally to data backup and mobile devices.

### BACKGROUND

Many modern mobile devices (e.g., a smart phone, tablet computer, wearable computer) have radio frequency transceivers that allow peer-to-peer communications with other mobile devices. Peer-to-peer communication capability allows the mobile devices to form a mobile ad hoc network, which is a self-configuring network of mobile devices. Each mobile device in the network is free to move independently in any direction and change its communication links to other mobile devices. Each mobile device can be configured to act a router for data destined for other mobile devices in the network. A mobile ad hoc network may be connected to a wide area network (e.g., Internet) and can communicate with servers through the Internet. In many situations, the user of a mobile device in the ad hoc network may be collecting data (e.g., photos, notes) at a time where there is no connectivity with a data backup server. If the mobile device is damaged, lost or stolen during this period of no connectivity, the data may be lost.

### SUMMARY

Ad hoc data backup for mobile devices is disclosed. When a user of a mobile device in a mobile ad hoc network has poor or no data connectivity with a network-based storage system and friends are identified that are in the vicinity of the user, backup data is transferred from the user's mobile device to one or more “friend devices” using peer-to-peer connections (e.g., WiFi, near field communications (NFC), Bluetooth). In some implementations, backup data is transferred only to those friend devices that have available storage to share and sufficient connection speed and battery life to perform backup operations. In some implementations, the backup data is encrypted using a secret key that may be known only to the user. In some implementations, the data backup has an expiration time (e.g., 1 week), after which time the data is automatically purged from the memory or disk of the friend devices.

After receiving backup data from the user's mobile device, the friend devices may notify the network-based storage system that backup data is available when the friend devices have connectivity with the network-based storage system. In some implementations, the friend devices send the stored backup data to the network-based storage system so that the backup data can be retrieved by the user at a later date (e.g., when connectivity is available for the user). In some implementations, the friend devices can send the backup data to the network-based storage system as a background process. The backup data can include a unique device identifier (UID), a timestamp indicating time of backup, data size, location information (if available) or any other information that can be used by the network-based storage system to identify and aggregate the backup data provided by multiple friend devices.

If the user needs to restore the backup data, the user can query or otherwise communicate (receive a push notification) with the network-based storage system for backup data availability. If the backup data is available, the user can restore the backup data to their mobile device or other desired device from the network-based storage system or directly from the friend devices if the friend devices are in the vicinity of the user's mobile device. In some implementations, the user can be notified when backup data that is currently unavailable will be available in the future. In some implementations, the user can request that the network-based storage system clear some or all data backups on one or more friend devices and/or the network-based storage system.

In some implementations, a method comprises: determining that a mobile device has a connectivity problem that prevents backing up data stored on the mobile device to a network-based storage system; identifying a friend device that is in the vicinity of the mobile device; sending a request to the friend device for participation in ad hoc data backup with the mobile device; receiving a response from the friend device agreeing to participate in the ad hoc data backup with the mobile device; determining that the friend device meets one or more criterion for participating in the ad hoc data backup; sending backup data to the friend device using a peer-to-peer connection with the friend device; at a time after the ad hoc data backup completes, receiving notification that the backup data is available from the network-based storage system or the friend device; and restoring the backup data to the mobile device from the network-based storage system or the friend device.

In some implementations, a method comprises: receiving a request from a mobile device requesting participation in ad hoc data backup with the mobile device; determining that one or more criterion are met for participating in ad hoc data backup with the mobile device; sending a response to the mobile device agreeing to participate in ad hoc data backup with the mobile device; receiving backup data from the mobile device using a peer-to-peer connection with the mobile device; at a time after the ad hoc data backup completes, sending notification that the backup data is available to the network-based storage system; and sending the backup data to the network-based storage system or the mobile device.

Other implementations are directed to systems, devices and computer-readable, storage mediums. Particular implementations disclosed herein provide one or more of the following advantages. Users of mobile devices can back up data to nearby friend devices when no connectivity to a network-based storage system is available, and restore the backup data at a later time when connectivity becomes available.

The details of the disclosed implementations are set forth in the accompanying drawings and the description below. Other features, objects and advantages are apparent from the description, drawings and claims.

### DESCRIPTION OF DRAWINGS

FIG. 1 illustrates an example operating environment for secure ad hoc data backup to nearby friend devices.

FIGS. 2A and 2B illustrate example processes performed by a client device requesting data backup.

FIGS. 3A and 3B illustrate example processes performed by a client device providing data backup.

FIG. 4 is a block diagram of example device architecture for the client devices described in reference to FIGS. 1-3.

FIG. 5 is a block diagram of an example operating environment for client devices having the architecture shown in FIG. 4.

The same reference symbol used in various drawings indicates like elements.

### DETAILED DESCRIPTION

### Example Illustrating Ad Hoc Data Backup

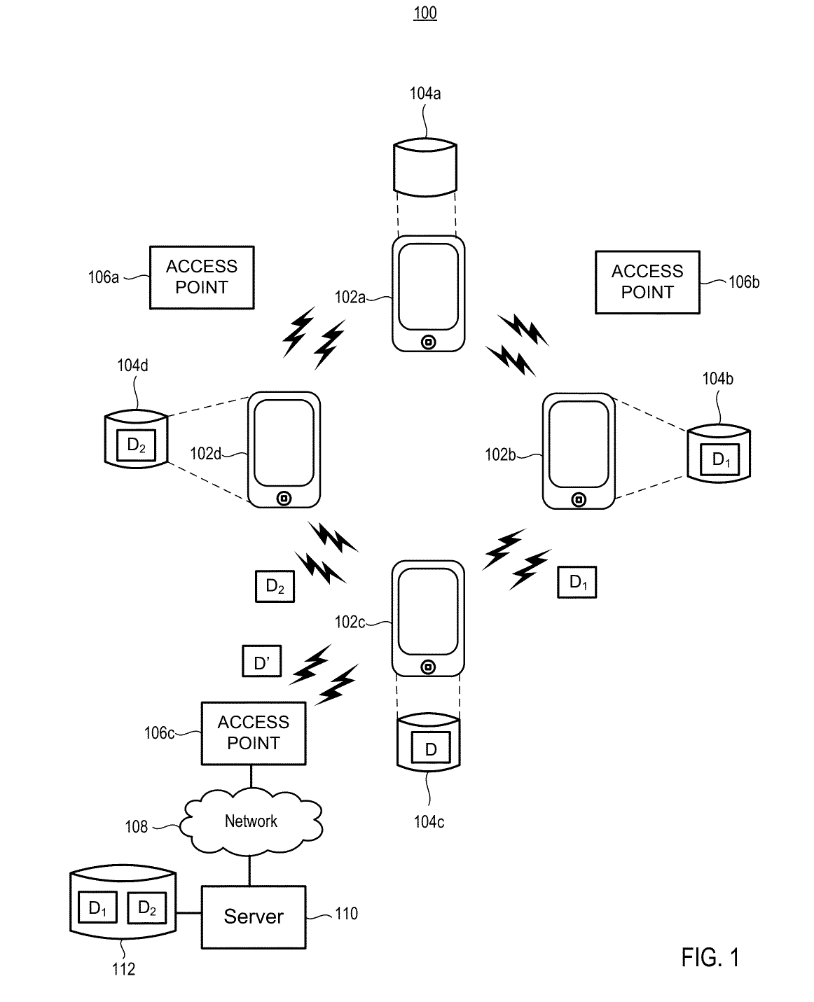

FIG. 1 illustrates an example operating environment 100 for secure ad hoc data backup to nearby friend devices. In the example shown, operating environment 100 includes devices 102a-d in peer-to-peer communication with each other. Devices 102a-d can be wired or wireless devices, including smartphones, tablet computers, notebook computers, wearable computers, etc. As used herein, peer-to-peer communications can include a peer-to-peer (P2P) network, which can be a decentralized and distributed network architecture in which individual nodes (e.g., smartphones, tablet computers) share resources (e.g., storage) and can communicate directly using one or more known communication protocols, such as WiFi, NFC and Bluetooth protocols.

Devices 102a-102d can be geographically co-located such that radio frequency (RF) signals transmitted by a device can be received directly by the other co-located devices. For example, each of devices 102a-102d can include a wireless transceiver that can scan the vicinity for beacon signals from other devices in the vicinity and establish a peer-to-peer connection with one of those other devices. Devices 102a-102d can also communicate with network access points (APs) 106a-106c to gain access to network 108 (e.g., the Internet). Although only AP 106c is shown coupled to network 108, each of access points 106a-106c can also be coupled to network 108. Network 108 can be coupled to a network-based storage system 110, which includes database 112 for storing backup data.

Operating environment 100 will now be described by way of an example use scenario. Device 102c is a smartphone with storage 104c storing data 104c (e.g., non-volatile memory). We assume in this use scenario that device 102c has poor or no connectivity to network-based storage system 110. Poor connectivity means the connectivity is not sufficient for transferring data. We assume the user of device 102c has been collecting and storing valuable personal data on device 102c, including photographs, e-mails, notes, applications or any other content. Because there is no connectivity to network-based storage system 110, the data or content stored on device 102 is vulnerable to being lost forever if device 102c is damaged, lost or stolen.

Device 102c has been enabled for WiFi scanning by the user and detects RF signals transmitted by nearby devices 102b, 102d in the WiFi scan. The RF signals include information that can be compared to information stored in device 102c. For example, the telephone numbers of devices 102b, 102d can be compared to phone numbers in an address book or contact database in device 102c to identify devices 102b, 102d as friends or buddies. Hereinafter, devices 102b, 102d will also be referred to as “friend” devices because the devices belong to individuals known to the user. Since the users of devices 102b, 102d are friends with the user of device 102c, they will be more willing to participate in ad hoc data backup with the user of device 102c.

Device 102c sends a request to devices 102b, 102d for ad hoc data backup. The request can be initiated by the user of device 102c providing input, such as touching a virtual button. The request can include information to assist devices 102b, 102d in determining the ability of devices 102b, 102d, to participate in ad hoc data backup. For example, the size of data to be backed up can be transferred with the request, as well as a minimum connection speed or bandwidth requirement. In response to the request, the users of devices 102b, 102d are provided with a message requesting their participation in ad hoc data backup with device 102c. The message can be displayed on a display screen of devices 102b, 102d, and can provide instructions for the users to opt-in or opt-out of participating in ad hoc data backup with device 102c. In some implementations, the friend can pre-configure their device 102b, 102d, using a settings pane or other user interface, to automatically allow ad hoc data backup with any other “friend” devices without having to opt-in. In some implementations, it is not necessary for the user to initiate the backup via any user action and instead the backup gets initiated automatically whenever necessary to friends who have allowed their devices to be used for ad hoc data backup.

If devices 102b, 102d are enabled to participate, then a memory manager, file system manager or other operating system component or application running on devices 102b, 102d can allocate a portion of memory or disk storage for storing ad hoc backup data from friend devices and also update a memory map, file allocation table or other appropriate data structure to ensure that the allocated portion of memory or disk spaced is reserved for backup data. Various criteria can be checked to ensure devices 102b, 102d can participate in ad hoc data backup. The criteria can include but is not limited to the amount of memory or disk storage available for backup data from device 102c, the peer-to-peer connection speed with device 102c and the power limitations of devices 102b, 102d. For example, if the battery life of device 102b is so low that an ad hoc data backup would consume more power than device 102b can provide, the power criterion is not met and device 102b cannot participate in the ad hoc data backup. In some implementations, criteria can include determining frequency of use by a candidate friend device of a particular communication technology. For example, a friend device that uses WiFi frequently in the past may be selected for ad hoc data backup over a friend device that frequently uses Bluetooth.

Devices 102b, 102d send responses to device 102c. The responses can include information on whether the device is enabled for ad hoc data backup (e.g., the user opted in), the available memory or disk space for the data backup, connection speed and remaining battery life. The criteria can be verified at the requesting mobile device or and/or the friend devices.

If devices 102b, 102d, meet the criteria, then device 102c transmits the backup data to one or both of devices 102b, 102d using peer-to-peer communications. If device 102b can allocate enough storage to store the entire data backup, then the entire data backup can be sent to device 102b. Otherwise, the data backup can be split between devices 102b, 102d according to the amount of memory or disk storage available on devices 102b, 102d. In the example shown, data D is split into two chunks: D₁ and D₂. Data chunk D₁ is backed up to storage 104b of device 102b and data chunk D₂ is backed up to storage 104d of device 102d. Although two backup devices 102b, 102d are disclosed in this example, any number of backup devices can participate in ad hoc data backup. In some implementations, backup data can be replicated across multiple friend devices for redundancy.

In some implementations, the backup data is encrypted by device 102c before the data is transmitted to devices 102b, 102d and only device 102c knows the secret key. The encryption provides a secure data backup so that the data cannot be reviewed or decrypted by users of devices 102b, 102d or third party hackers. Standard encryption algorithms (e.g., AES, DES) and/or proprietary encryption algorithms may be used.

In some implementations, the data backup can have an expiration time, after which time the backup data is automatically purged or otherwise removed or deleted from devices 102b, 102d. The purging can be performed by the devices 102b, 102d upon expiration of a timer or in response to a trigger event, such as in response to a signal from network-based storage system 110. In some implementations, the user of device 102c can initiate the purging of data from devices 102b, 102d.

Continuing with the present example, after the data backup is completed devices 102b, 102d can notify network-based storage system 110 that backed up data is available for device 102c. The notification can be transmitted through, for example, APs 106a and 106b. The backup data can be transferred to network-based storage system 110 by devices 102b, 102d whenever connectivity is available to network-based storage system 110. When device 102c regains connectivity with network-based storage system 110, device 102c receives notification that backup data is available from devices 102b, 102d. In some implementations, the user of device 102c can be notified when the data backup will be available in the future. For example, the friend may be on vacation and will not have connectivity with the network-based storage system 110 until the friend returns from their vacation. Such information could be harvested from the friend's calendar stored at the network-based storage system 110.

The backup data D′ can be restored to device 102c or other device specified by the user of device 102c. The restoration of backup data can be automatic or manually initiated by the user. The data transfer between devices 102b, 102c, 102d and network-based storage system 110 can be performed transparently as a background process. The transfer can be done during windows of opportunity (e.g., during periods of inactivity or when the device is plugged into a power source) and can be transferred in data chunks whenever connectivity is available.

### Example Processes

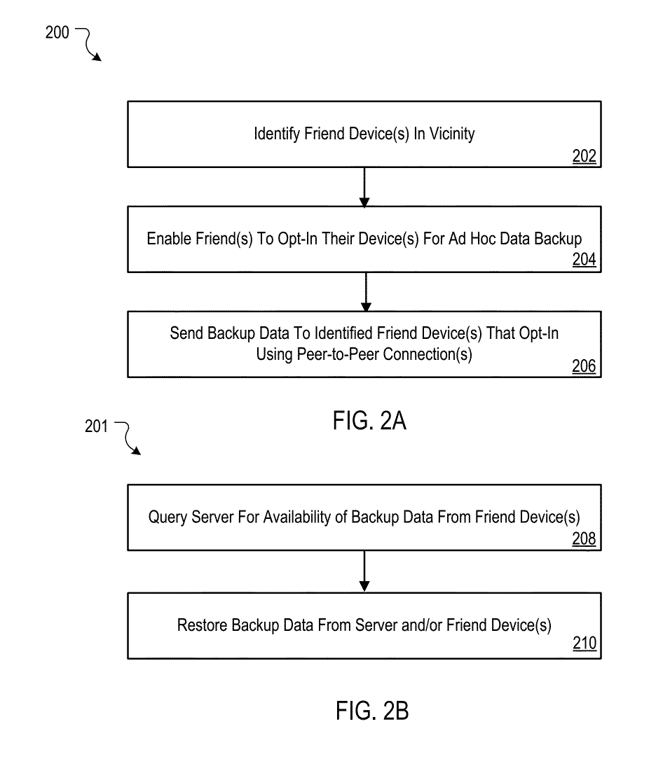

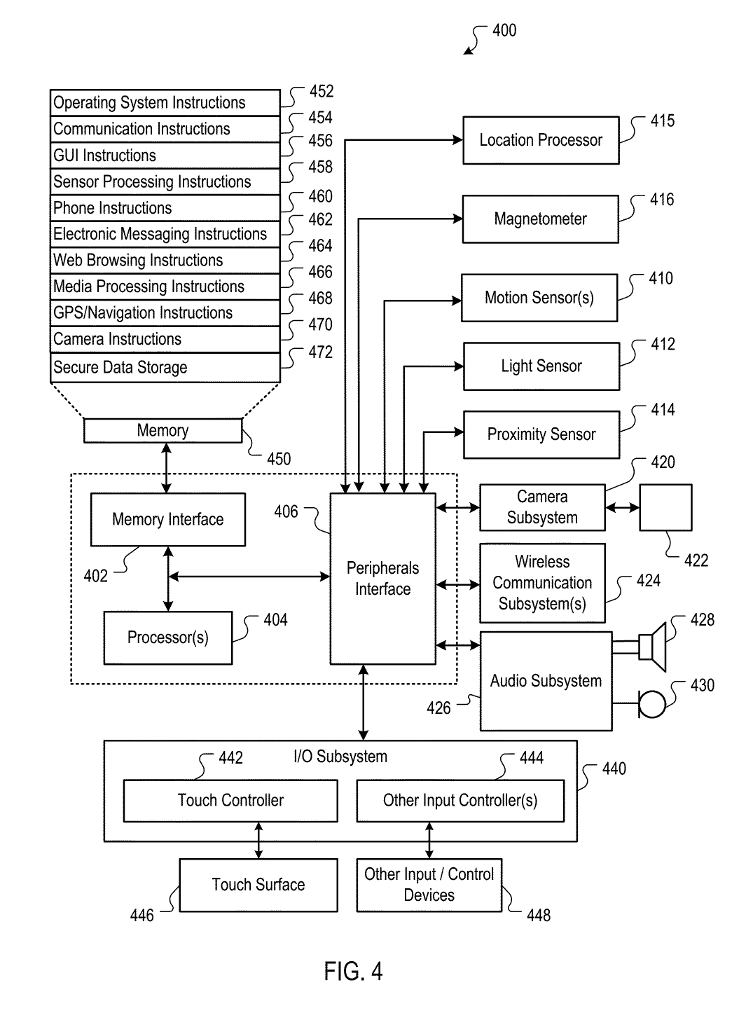

FIGS. 2A-2B illustrates example processes 200, 201 performed by a client device requesting data backup. Processes 200, 201 can be implemented by device architecture 400, as described in reference to FIG. 4.

Referring now to FIG. 2A, process 200 can begin by identifying one or more friend devices in the vicinity of the mobile device (202). As used herein, “in the vicinity” means the friend device is physically close enough to the mobile device to receive RF signals transmitted by the mobile device. For example, a wireless transceiver on the mobile device can initiate a WiFi, Bluetooth or NFC scan for RF signals. The scan results in a list of devices that were detected by the scan. The list can be compared to information stored on the mobile device (e.g., an address book, buddy list or other contact database) to identify the device as a friend device.

Process 200 can continue by enabling the friend(s) to opt-in their device(s) for ad hoc data backup (204). For example, a message can be displayed to the friend of the user providing instructions on a display screen of the friend device describing how to opt-in to ad hoc data backup. In some implementations, the opt-in can be automatic if the friend previously activated a setting allowing for automatic opt-in in response to requests for ad hoc data backup.

Process 200 can continue by sending data to the identified friend device(s) that opted in using peer-to-peer communications (206). The data can be encrypted at the mobile device before sending to the friend device(s). The data can include media (e.g., photos, video) if the storage capacity available on the friend device(s) and the connection speed and bandwidth make data backup feasible.

Referring now to FIG. 2B, process 201 can begin by the mobile device querying a server of a network-based storage system for availability of backup data from friend devices (208). In some implementations, the network-based storage system can send a notification to the mobile device when backup data is available from friend devices. Process 201 can continue by restoring the backup data from the network-based storage system and/or directly from the friend devices storing the backup data, if in the vicinity of the mobile device during the restore operation (210).

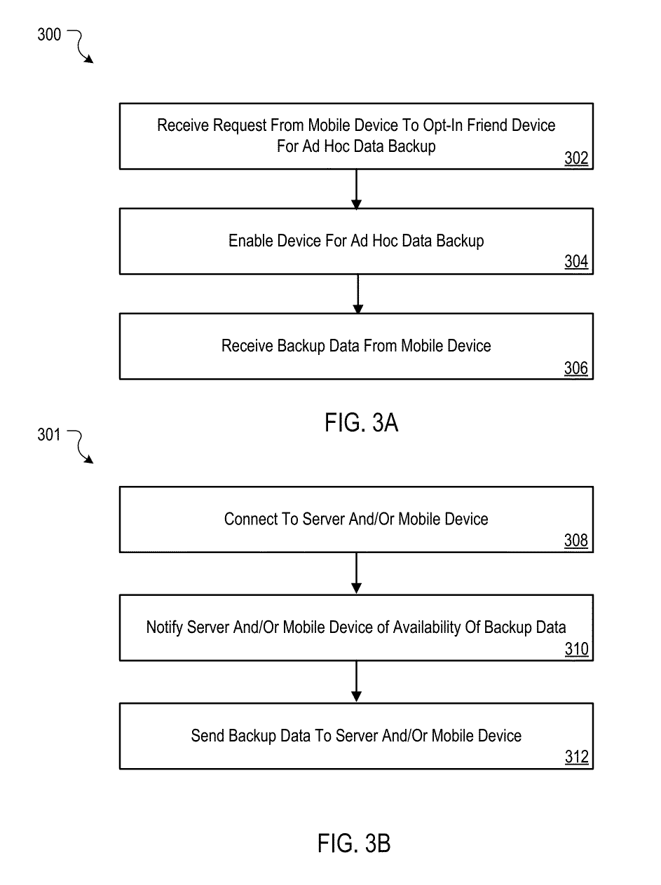

FIGS. 3A and 3B illustrate example processes 300, 301 performed by a client device providing data backup. Processes 300, 301 can be implemented by device architecture 400, as described in reference to FIG. 4.

Referring now to FIG. 3A, process 300 can begin by receiving a request from a mobile device to opt-in the friend device for ad hoc data backup (302). For example, in response to the request, a message can be presented on a display screen of the friend device providing instructions on how to opt-in or opt-out by providing input, such as touching virtual button presented on a graphical user interface (GUI) or providing some other input.

Process 300 can continue by enabling the friend device for ad hoc data backup (304). For example, a memory manager, file system manager or other operating system component or application can allocate memory or disk storage for ad hoc data backup. The friend device can also verify that criteria for data backup are met such as storage availability, connection speed and battery life. If the criteria are met, the friend device can send a response to the mobile device indicating that the friend device will participate in ad hoc data backup with the mobile device. In some implementations, the criteria can be verified at the mobile device or at both the mobile device and the friend device.

Process 300 can continue by receiving backup data from the mobile device (306). The backup data can be encrypted and stored in a secure area of the allocated storage. A timer on the friend device when the backup is complete. When the timer expires the backup data can be purged or otherwise removed or deleted from storage. Backup data can include media content (e.g., pictures, video), provided there enough storage capacity on the friend device and the connection speed is fast enough.

Referring now to FIG. 3B, process 301 can begin by the friend device connecting with a server of a network-based storage system and/or the mobile device and requesting a restore operation (308). An example network-based storage system is iCloud®, which is operated by Apple Inc. of Cupertino, Calif., USA.

Process 301 can continue by notifying the server and/or mobile device of the availability of backup data from the friend device (310) and then sending the backup data to the server and/or to the mobile device, if the friend device is in the vicinity of the mobile device (312).

### Example Mobile Device Architecture

FIG. 4 is a block diagram of example device architecture for the client devices described in reference to FIGS. 1-3. Architecture 400 may be implemented in any device for generating the features described in reference to FIGS. 1-3, including but not limited to portable computers, smart phones and electronic tablets, game consoles, wearable devices and the like. Architecture 400 may include memory interface 402, data processor(s), image processor(s) or central processing unit(s) 404, and peripherals interface 406. Memory interface 402, processor(s) 404 or peripherals interface 406 may be separate components or may be integrated in one or more integrated circuits. One or more communication buses or signal lines may couple the various components.

Sensors, devices, and subsystems may be coupled to peripherals interface 406 to facilitate multiple functionalities. For example, motion sensor 410, light sensor 412, and proximity sensor 414 may be coupled to peripherals interface 406 to facilitate orientation, lighting, and proximity functions of the device. For example, in some implementations, light sensor 412 may be utilized to facilitate adjusting the brightness of touch surface 446. In some implementations, motion sensor 410 (e.g., an accelerometer, gyros) may be utilized to detect movement and orientation of the device. Accordingly, display objects or media may be presented according to a detected orientation (e.g., portrait or landscape).

Other sensors may also be connected to peripherals interface 406, such as a temperature sensor, a biometric sensor, or other sensing device, to facilitate related functionalities.

Location processor 415 (e.g., GPS receiver chip) may be connected to peripherals interface 406 to provide geo-positioning. Electronic magnetometer 416 (e.g., an integrated circuit chip) may also be connected to peripherals interface 406 to provide data that may be used to determine the direction of magnetic North. Thus, electronic magnetometer 416 may be used as an electronic compass.

Camera subsystem 420 and an optical sensor 422, e.g., a charged coupled device (CCD) or a complementary metal-oxide semiconductor (CMOS) optical sensor, may be utilized to facilitate camera functions, such as recording photographs and video clips.

Communication functions may be facilitated through one or more communication subsystems 424. Communication subsystem(s) 424 may include one or more wireless communication subsystems. Wireless communication subsystems 424 may include radio frequency receivers and transmitters and/or optical (e.g., infrared) receivers and transmitters. Wired communication system may include a port device, e.g., a Universal Serial Bus (USB) port or some other wired port connection that may be used to establish a wired connection to other computing devices, such as other communication devices, network access devices, a personal computer, a printer, a display screen, or other processing devices capable of receiving or transmitting data.

The specific design and implementation of the communication subsystem 424 may depend on the communication network(s) or medium(s) over which the device is intended to operate. For example, a device may include wireless communication subsystems designed to operate over a global system for mobile communications (GSM) network, a GPRS network, an enhanced data GSM environment (EDGE) network, 802.x communication networks (e.g., Wi-Fi, Wi-Max), code division multiple access (CDMA) networks, NFC and a Bluetooth™ network. Communication subsystems 424 may include hosting protocols such that the device may be configured as a base station for other wireless devices. As another example, the communication subsystems may allow the device to synchronize with a host device using one or more protocols, such as, for example, the TCP/IP protocol, HTTP protocol, UDP protocol, and any other known protocol.

Audio subsystem 426 may be coupled to a speaker 428 and one or more microphones 430 to facilitate voice-enabled functions, such as voice recognition, voice replication, digital recording, and telephony functions.

I/O subsystem 440 may include touch controller 442 and/or other input controller(s) 444. Touch controller 442 may be coupled to a touch surface 446. Touch surface 446 and touch controller 442 may, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch surface 446. In one implementation, touch surface 446 may display virtual or soft buttons and a virtual keyboard, which may be used as an input/output device by the user.

Other input controller(s) 444 may be coupled to other input/control devices 448, such as one or more buttons, rocker switches, thumb-wheel, infrared port, USB port, and/or a pointer device such as a stylus. The one or more buttons (not shown) may include an up/down button for volume control of speaker 428 and/or microphone 430.

In some implementations, device 400 may present recorded audio and/or video files, such as MP3, AAC, and MPEG video files. In some implementations, device 400 may include the functionality of an MP3 player and may include a pin connector for tethering to other devices. Other input/output and control devices may be used.

Memory interface 402 may be coupled to memory 450. Memory 450 may include high-speed random access memory or non-volatile memory, such as one or more magnetic disk storage devices, one or more optical storage devices, or flash memory (e.g., NAND, NOR). Memory 450 may store operating system 452, such as Darwin, RTXC, LINUX, UNIX, OS X, WINDOWS, or an embedded operating system such as VxWorks. Operating system 452 may include instructions for handling basic system services and for performing hardware dependent tasks. In some implementations, operating system 452 may include a kernel (e.g., UNIX kernel).

Memory 450 may also store communication instructions 454 to facilitate communicating with one or more additional devices, one or more computers or servers, including peer-to-peer communications, as described in reference to FIGS. 1-3. Communication instructions 454 may also be used to select an operational mode or communication medium for use by the device, based on a geographic location (obtained by the GPS/Navigation instructions 468) of the device. Memory 450 may include graphical user interface instructions 456 to facilitate graphic user interface processing, including a touch model for interpreting touch inputs and gestures; sensor processing instructions 458 to facilitate sensor-related processing and functions; phone instructions 460 to facilitate phone-related processes and functions; electronic messaging instructions 462 to facilitate electronic-messaging related processes and functions; web browsing instructions 464 to facilitate web browsing-related processes and functions; media processing instructions 466 to facilitate media processing-related processes and functions; GPS/Navigation instructions 468 to facilitate GPS and navigation-related processes; camera instructions 470 to facilitate camera-related processes and functions; and secure storage 472 for storing secure ad hoc data backups, as described in reference to FIGS. 1-3.

Each of the above identified instructions and applications may correspond to a set of instructions for performing one or more functions described above. These instructions need not be implemented as separate software programs, procedures, or modules. Memory 450 may include additional instructions or fewer instructions. Furthermore, various functions of the device may be implemented in hardware and/or in software, including in one or more signal processing and/or application specific integrated circuits (ASICs).

### Example Operating Environment

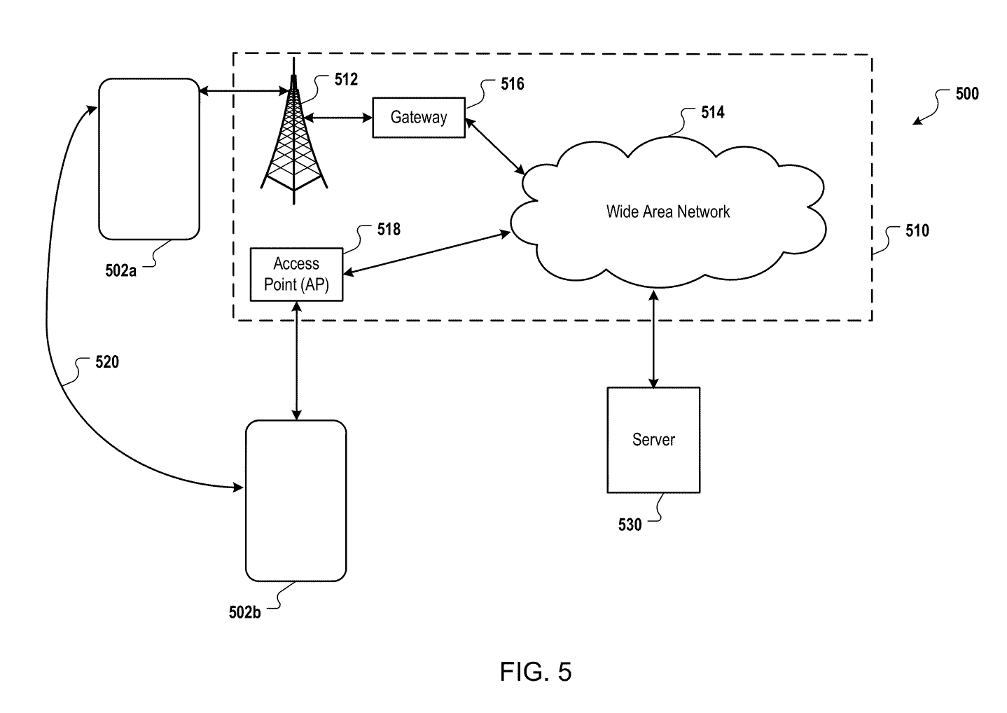

FIG. 5 is a block diagram of an example operating environment for client devices having the architecture shown in FIG. 4. Mobile devices 502a and 502b can, for example, communicate over one or more wired and/or wireless networks 510. For example, a wireless network 512, e.g., a cellular network, can communicate with a wide area network (WAN) 514, such as the Internet, by use of a gateway 516. Likewise, an access point (AP) 518, such as an 802.11g wireless access point, can provide communication access to the wide area network 514.

In some implementations, both voice and data communications can be established over wireless network 512 and the access point 518. For example, mobile device 502a can place and receive phone calls (e.g., using voice over Internet Protocol (VoIP) protocols), send and receive e-mail messages (e.g., using Post Office Protocol 3 (POP3)), and retrieve electronic documents and/or streams, such as web pages, photographs, and videos, over wireless network 512, gateway 516, and wide area network 514 (e.g., using Transmission Control Protocol/Internet Protocol (TCP/IP) or User Datagram Protocol (UDP)). Likewise, in some implementations, the mobile device 502b can place and receive phone calls, send and receive e-mail messages, and retrieve electronic documents over the access point 518 and the wide area network 514. In some implementations, mobile device 502a or 502b can be physically connected to the access point 518 using one or more cables and the access point 518 can be a personal computer. In this configuration, mobile device 502a or 502b can be referred to as a “tethered” device.

Mobile devices 502a and 502b can also establish communications by other means. For example, wireless device 502a can communicate with other wireless devices, e.g., other mobile devices, cell phones, etc., over the wireless network 512. Likewise, mobile devices 502a and 502b can establish peer-to-peer communications 520, e.g., a personal area network, by use of one or more communication subsystems, such as the Bluetooth, Wi-Fi or NFC communication devices. Other communication protocols and topologies can also be implemented.

The mobile device 502a or 502b can, for example, communicate with one or more services or server computers 530 (e.g., mapping or navigation service) over the one or more wired and/or wireless networks. Mobile device 502a or 502b can also access other data and content over the one or more wired and/or wireless networks. For example, content publishers, such as news sites, Really Simple Syndication (RSS) feeds, web sites, blogs, social networking sites, developer networks, etc., can be accessed by mobile device 502a or 502b. Such access can be provided by invocation of a web browsing function or application (e.g., a browser) in response to a user touching, for example, a Web object.

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with an author, the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

As described above, some aspects of the subject matter of this specification include gathering and use of data available from various sources to improve services a mobile device can provide to a user. The present disclosure contemplates that in some instances, this gathered data may identify a particular location or an address based on device usage. Such personal information data can include location-based data, addresses, subscriber account identifiers, or other identifying information.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In the case of advertisement delivery services, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
determining that a mobile device has a connectivity problem that prevents backing up data stored on the mobile device to a network-based storage system;
identifying a friend device that is in the vicinity of the mobile device;
sending a request to the friend device for participation in ad hoc data backup with the mobile device;
receiving a response from the friend device agreeing to participate in the ad hoc data backup with the mobile device;
determining that the friend device meets one or more criterion for participating in the ad hoc data backup;
sending backup data to the friend device using a peer-to-peer connection with the friend device;
at a time after the ad hoc data backup completes, receiving notification that the backed up data is available from the network-based storage system or the friend device; and
restoring the backup data to the mobile device from the network-based storage system or the friend device,
where the method is performed by one or more hardware processors.

2. The method of claim 1, where identifying a friend device that is in the vicinity of the mobile further comprises:
scanning the vicinity for radio frequency signals;
detecting from the scan a radio frequency signal from the friend device;
comparing information provided by the radio frequency signal with information associated with the friend device that is stored on the mobile device; and
identifying the friend device based on a result of the comparing.

3. The method of claim 1, where one criterion is that the friend device has storage space available for ad hoc data backup.

4. The method of claim 1, where one criterion is that the friend device has a desired connection speed or bandwidth.

5. The method of claim 1, where one criterion is that the friend device is connected to a power source or has a battery charge above a specified value.

6. The method of claim 1, where the backup data is encrypted.

7. The method of claim 1, where the request or backup data includes a parameter that specifies the size of backup data.

8. The method of claim 1, where the backup data includes a timestamp indicating the time of backup.

9. The method of claim 1, where the response from the friend device is sent in response to input provided at the friend device providing authorization to allow ad hoc data backup on the friend device.

10. The method of claim 1, where the response includes information that is used by the mobile device to determine if the one or more criterion is met.

11. The method of claim 1, further comprising:
receiving notification that the backup data will be available from the friend device at a future date.

12. The method of claim 1, further comprising:
sending one or more instructions to the network-based storage system or the friend device to purge the backup data stored in the network-based storage system or the friend device.

13. The method of claim 1, where the backup data is associated with an expiration time after which time the backup data on the friend device is purged, removed or deleted.

14. The method of claim 1, where the backup data stored on the friend device is purged, removed or deleted after the backup data is sent to the network-based storage system.

15. A method comprising:
receiving a request from a mobile device requesting participation in ad hoc data backup with the mobile device;
determining that one or more criterion are met for participating in ad hoc data backup with the mobile device;
sending a response to the mobile device agreeing to participate in ad hoc data backup with the mobile device;
receiving backup data from the mobile device using a peer-to-peer connection with the mobile device;
at a time after the ad hoc data backup completes, sending notification that the backup data is available to the network-based storage system; and
sending the back up data to the network-based storage system or the mobile device,
where the method is performed by one or more hardware processors.

16. The method of claim 15, where one criterion is that the friend device has storage space available for ad hoc data backup.

17. The method of claim 15, where one criterion is that the friend device has a desired connection speed or bandwidth.

18. The method of claim 15, where one criterion is that the friend device is connected to a power source or has a battery charge above a specified value.

19. The method of claim 15, where the backup data is encrypted.

20. The method of claim 15, where the request or backup data includes a parameter that specifies the size of the backup data.

21. The method of claim 15, where the backup data includes a timestamp indicating the time of data backup.

22. The method of claim 15, further comprising:
displaying a message on a display of the friend device requesting authorization or opt-in to ad hoc data backup with the mobile device; and
responsive to the message, receiving user input for allowing ad hoc backup on the friend device.

23. The method of claim 15, where the response includes information that is used by the mobile device to determine if the one or more criterion is met.

24. The method of claim 15, further comprising:
sending a notification that the backup data will be available from the friend device at a future date.

25. The method of claim 15, further comprising:
receiving one or more instructions to purge the backup data stored in the friend device.

26. The method of claim 25, where the backup data stored on the friend device is purged, removed or deleted after the backup data is sent to the network-based storage system or the mobile device.

27. The method of claim 15, where the backup data is associated with an expiration time after which time the backup data on the friend device is purged, removed or deleted.
